(19) United States
(12) Patent Application Publication
(10) Pub. No.: US 2004/0034560 A1
(43) Pub. Date: Feb. 19, 2004

(54) Method of doing business and associated apparatus

(76) Inventor: Torrance Mathis, Brooklyn, NY (US)

Correspondence Address: Alfred F. Hoyte, Esq., 7734 16th Street, N.W., Washington, DC, 20012, US

(21) Appl. No.: 10/217,030

(22) Filed: Aug. 13, 2002

(51) Int. Cl. G06F 17/60

(52) U.S. Cl. 705/14

(57) ABSTRACT

A method for diverting the attention of customers to an advertisement of a particular product or service. A series of motivational slogans are broadcasted for reception via television or radio, or otherwise disseminated at precisely 9:11 a.m. and 9:11 p.m. daily, in reverence to the September 11^{th} tragedy. After dissemination of the slogans, advertising material may be disseminated. The slogans may be electronically stored on a timepiece which includes an audio transducer. The timepiece, which includes a logo associated with a specific business or organization, is synchronized to output an audible version of the slogans.

### BACKGROUND OF THE INVENTION

1. Field of the Invention

The present invention concerns a method and associated apparatus for obtaining the attention of potential consumers. More particularly, the invention is directed to an attention brokerage method which utilizes positive motivation, broadcasted or otherwise disseminated at specific times, to attract the attention of consumers.

2. Description of the Prior Art

U.S. Pat. No. 5,794,210 issued to Goldhaber, et al. discloses a typical attention brokerage method adapted for use on the internet. An advertiser causes an icon to be displayed on the user's computer screen, “clicking” on the icon will initiate the deposition of a small amount of money to the user's account, provided the user reads the advertising. Various software methods are employed to ensure that the user has complied with the request to review the ad before the user's account is credited. This method and other similar methods suffer from the drawback in that the transaction must occur over the internet, there is no alternative way to facilitate the transaction. Also, the sponsoring company must pay each user, many of whom have no real interest in the underlying product or service.

The present invention differs from the prior art methods in that the incentive offered is not monetary, but psychological. Americans have been inundated with negative news and dire warnings since the September 11^{th} tragedy. The effect on the collective American psyche has been dramatic. Airline travel and tourism in general are at all time lows, and the economy has suffered as a result. While the government has been careful to acknowledge the inevitability of another terrorist attack, no steps have been taken to deal with the macro-psychological impact of such an attack. While earnest displays of patriotism often immediately follow such tragedies, those impulses tend to wane in just a few weeks while the general sense of malaise and trepidation continue.

Accordingly, a marketing concept which stresses positive motivation while directing potential consumers to a specific product or service would be desirable. The present invention provides such a marketing concept, and, unlike attention brokering which is restricted to use on the internet, the present concept can be used in a variety of different advertising mediums.

In one aspect of the invention, an apparatus and associated method of doing business is provided. A retail or service provider would provide the apparatus to potential customers/clients either as a promotional item or for a relatively low cost. The apparatus is a wristwatch having an audio transducer, electronic alarm means, and voice data storage means. The method of doing business includes the steps of first, providing the watch with voice data corresponding to a series of motivational slogans which are triggered precisely at 9:11. a.m. and 9:11 p.m every day of the week. Each time slot will have a different slogan for at least a seven day cycle before a slogan is repeated. The slogans are associated with the particular retail or service provider, which may be a non-profit organization, corporation, or retail business which distributes the watch, the slogans worded to provide positive motivation to individuals in light of the September 11^{th} tragedy. Second, various promotional and advertising schemes are launched to ensure that the public associates the slogans with the particular organization, corporation, or retail business which distributes the watch. Thus, by repetition, the prerecorded slogan reinforces e.g., brand loyalty, or corporate loyalty, without directly advertising a particular brand or corporation.

In accordance with another aspect of the invention, a radio or television broadcast, again delivered at 9:11 a.m. and p.m., would begin with the motivational slogan, followed by an advertisement of a particular product or service offered by the retail business or service provider. The particular product or service would be discounted beginning at 9:11 (a.m. or p.m.) and ending after a specified duration.

In accordance with another aspect of the invention, software is downloaded from a central computer by a potential customer, the software capable of generating an icon which serves as a link to the website hosted by the central computer. The link would be initiated at 9:11 a.m. and p.m., by the presentation of an icon on the users computer. The user can click on the icon whereupon he/she is presented with a slogan which may be in an audio-visual format. After the user reads the slogan, he must click on an exit icon, which causes the display of advertising information associated with a sponsor approved by the website.

In another aspect of the invention a smart card is issued to each purchaser or recipient of the promotional watch. The smart card, once activated, will allow the purchaser to receive discounts on merchandise or services offered for sale by the retail or service provider. Activation of the card will allow the retail or service provider to track purchases by individual users. Used in combination with the internet service, the user, after clicking the exit icon, would be presented with discounts on products likely to be of interest based on purchasing history.

None of the above inventions and patents, taken either singly or in combination, is seen to describe the instant invention as claimed.

### SUMMARY OF THE INVENTION

Briefly, the invention comprises a method for diverting the attention of customers to an advertisement of a particular product or service. A series of motivational slogans are broadcasted for reception via television or radio, or otherwise disseminated at precisely 9:11 a.m. and 9:11 p.m. daily, in reverence to the September 11^{th} tragedy. After dissemination of the slogans, advertising material may be disseminated. The slogans may be electronically stored on a timepiece which includes an audio transducer. The timepiece, which includes a logo associated with the present scheme, is synchronized to output an audible version of the slogans.

Accordingly, it is a principal object of the invention to provide new and improved methods of attention brokering.

It is a major object of this invention to provide a method of attention brokering which employs positive motivation in lieu of cash payment to reward potential consumers.

It is another object of the invention to provide a method of attention brokering which may be implemented in a variety of different mediums.

It is another object of the invention to provide a method of attention brokering which employs a pager to alert potential consumers of an imminent broadcast of a motivational slogan.

It is another object of the invention to provide a method of attention brokering which employs a wristwatch which outputs an audible version of the motivational slogans.

It is another object of the invention to provide a method of attention brokering which uses a smart card to track purchases by users to allow for sales and promotions to be tailored to a specific user's purchasing profile.

Finally, it is a general goal of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

The present invention meets or exceeds all the above objects and goals. Upon further study of the specification and appended claims, further objects and advantages of this invention will become apparent to those skilled in the art.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic representation of the attention brokerage method of the present invention.

FIG. 2 is a plan view of a wristwatch to be used with the attention brokerage method of the present invention.

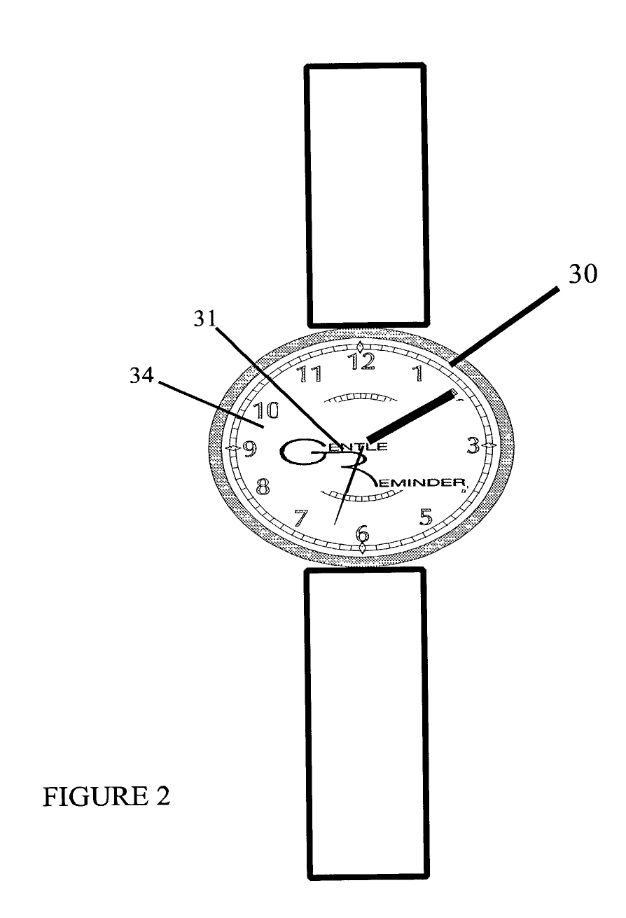

### DETAILED DESCRIPTION OF THE PREFERRED EMBODIMENTS

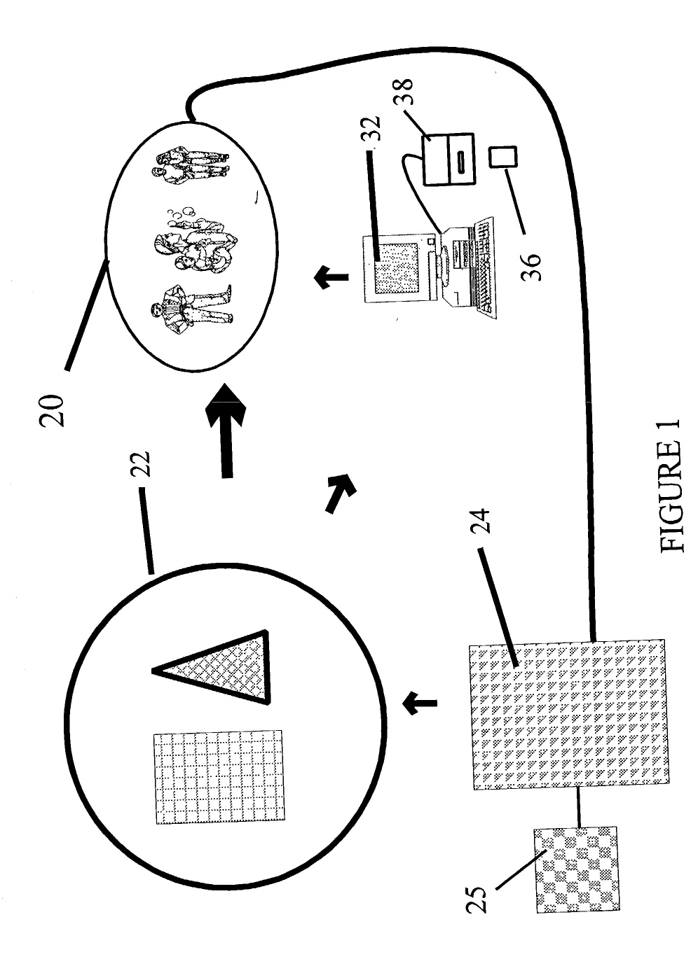

Referring now to FIG. 1, a diagrammatic representation of the scheme of the present invention is shown. A consumer or patron 20 is motivated to direct his/her attention to a particular advertisement or other audio/visual presentation disseminated for public receipt, in anticipation of receiving one of a series of motivational slogans. Consumers 20 receive motivational slogans, triggered at 9:11 a.m. and p.m., daily, via broadcast medium or over the internet, preceded and/or followed by an advertisement, notice of a promotional contest, or other acknowledgment of the entity which originates the broadcast or transmission. The motivational slogans, which may be repeated on a weekly basis, may be prepared for broadcast by a television or radio station 22 at the request of a third party, which may be a chain of retail stores or other commercial entity 24. Alternatively, a radio or television station 22 may broadcast the motivational slogan as part of an internal promotional or marketing plan.

Supplemental to the broadcast, a wristwatch 30, which is preferably a low cost promotional giveaway, has a series of motivational slogans digitally stored therein. The wristwatch 30 includes an audio transducer, electronic alarm means, and voice data storage means. The voice data storage means (not shown) allows for storage of a limited amount of voice data and may be any one of several commonly available data storage chips suitably sized for containment within the watch 30. The audio transducer (not shown), which is also suitably sized, is inconspicuously placed and capable of announcing the slogans at intervals determined by the alarm means, which is preprogrammed. Preferably, a logo 31 associated with the promotional scheme of the invention is rendered onto the watch face 34. Audible reproductions of the motivational slogans are triggered by the alarm means precisely at 9:11, a.m. and p.m, every day of the week, with both the 9 and the 11 on the face of the wristwatch 30 having an asterisk or other distinguishing feature. Each time slot will have a different slogan for at least a seven day cycle before a slogan is repeated. The slogans may be associated with the organization, corporation, or retail business 24 which distributes the watch 30, the slogans worded to provide positive motivation to individuals in light of the September 11^{th} tragedy. Various promotional and advertising schemes are launched to ensure that the public associates the slogans with the particular organization, corporation, or retail business 24 which distributes the watch. Thus, by repetition, the prerecorded slogan reinforces, e.g., brand loyalty or corporate loyalty, without directly advertising a particular brand or corporation. Also, if the commercial entity 24 which distributes the watch 30 is a sales or service provider, discounts can be offered on specific items or services beginning at 9:11 a.m. and 9:11 p.m. and ending after a specified duration. The daily announcements of the slogan by the watch 30 transducer coincides with the initiation of the sale and serves as a reminder of the daily discount to the wearer of the watch 30. The advertising campaign keeps potential customers informed of the discounts, identifying the specific items or services to be discounted.

In lieu of a watch 30, a pager (not shown) may be used to both present the slogan and announce the discounts.

In accordance with another aspect of the invention, the motivational slogan is in the form of a news break occurring during the broadcast of a radio or television program. The news break will focus on some heroic act performed by a police officer, fireman, citizen, etc., which act reflects heroic conduct. A series of heroic news breaks, each covering a different event, which might, e.g., be read by a local newscaster or celebrity and taped by a local television station, is aired daily at 9:11 a.m. and p.m. Each news break will be preceded and/or followed by an advertisement or other message from an entity which sponsors the airing of the news break. For example, a local department store sponsoring the news break might air the news break between announcements of sales on specific items. Of course, any type of announcement or advertisement might accompany the news break such as notice of contests, solicitations of monetary donations, solicitations of blood donations, liquidation sales, etc. The sales, contests, solicitations of monetary donations, etc., begin at 9:11 a.m. or p.m., and run for an hour or some other specified limited duration.

In accordance with another aspect of the invention, the motivational slogan will be disseminated by announcement over a PA system at a sporting venue, conference hall, shopping mall or other public venue. The announcements, starting at 9:11 a.m. and p.m. daily, will be followed by an advertisement or other message. For example, in the context of a shopping mall, a ten minute discount may be offered at a sponsoring retail store.

It should be noted that the presentation of the slogan is performed in such a way as to have a positive effect on a listener, even if the listener is already familiar with the slogan. Thus, the slogan may be performed by a well known motivational speaker or religious icon, who may offer a unique interpretation or presentation of the slogan. In this manner, the listener will continue to look forward to hearing the slogan, as it may be performed by a local or national minister with whom he/she is familiar.

In accordance with another aspect of the invention, the sponsoring entity 24 having a web page running on a server or central computer 25, will have the capacity to send a program to selected users which causes the appearance of an icon on the user's display screen. The icon will appear on a user's monitor 32, again at 9:11 a.m. and p.m., and will direct a user to a website, where the user may enter, in typed form from the computer keyboard, a solution to a global problem such as terrorism, world hunger, crime, etc. The user will hit an exit icon appearing on the monitor 32, whereupon an advertisement for goods or services will be triggered and transmitted for display on the users monitor 32. If the user has been issued a smart card, as described below, the goods and services advertised will be selected based on a particular usage history.

In accordance with another aspect of the invention, the issuing entity 24 issues a smart card 36, and a smart card reader 38 to consumers wishing to participate in the marketing scheme of the invention. Each time the consumer makes a purchase at a participating outlet owned by or affiliated with the issuing entity and gives the card 36 to the cashier, a serial number associated with the card 36 is identified by a local card reading apparatus connected to a phone network and the card, after acknowledgment and verification by the central computer 25 is credited with a purchase. The central computer 25 tracks the purchases to generate a user profile, which is then used to tailor advertising for the particular individual. Also, additional discounts may be awarded based on frequent purchases. The smart card 36 may be bar coded and may include a magnetic stripe as is well known in the art. The smart card reader 38 allows the consumer to enter personal data for storage on the card's micro-chip, allowing for recognition of the user when the card 36 is used over the internet or at participating retail venues. Also, a predetermined dollar amount may be stored on the card 36, as authorized and controlled solely by the central computer 25, and money may be subtracted at the participating venues as purchases are made. Activation of the card 36 may be accomplished over the internet using personal data entered using the card reader 38, or by calling a phone number associated with the card issuer 24, where an operator enters the personal data for storage on the central computer 25.

If the watch 30 is sold, as opposed to given away, a CD containing recordings of the motivational slogans as read by a performer, and the card reader 38 is given away along with the watch. Thus, the purchaser of the watch 30 is encouraged to participate fully with all aspects of the system of the invention.

TABLE I
Sunday Affirmations:
The time is now 9:11 - Affirm your spiritual connection with your
creator.
The time is now 9:11 - Become a productive part of your workplace,
community and Nation.
Monday Affirmations:
The time is now 9:11 - Be excellent at what you do and complete what
you start.
The time is now 9:11 - I must exercise my body to strengthen my mind.
Tuesday Affirmations:
The time is now 9:11 - I will be silent to hear the sound of love within
me.
The time is now 9:11 - This moment I will connect with my family, those
near or far.
Wednesday Affirmations:
The time is now 9:11 - This week I will give 4 hours of my time to the
community.
The time is now 9:11 - This moment is dedicated to my loved one.
Thursday Affirmations:
The time is now 9:11 - Say hello to a stranger, wave driver to driver or
shake the hand of a friend.
The time is now 9:11 - I will take this moment to be thankful for the
blessings in my life.
Friday Affirmations:
The time is now 9:11 - Eating healthy will serve my family, community
and nation.
The time is now 9:11 - Study hard and perfect your craft to serve the
greater good.
Saturday Affirmations:
The time is now 9:11 - Discover something new about another culture to
expand your global understanding.
The time is now 9:11 - Learn a new word every week to make yourself
strong.

Referring now to Table I, a list of representative slogans is shown. It can be seen that one of the slogans relates to learning a weekly or daily word to build one's vocabulary. The word, which will be in more than one language and is preferably a word identified with a particular culture or ethnic group, can be used to facilitate cultural exchange, an important aspect to the healing process. A newspaper or bookstore having exclusive rights to the use of the scheme of the invention can generate increased advertising revenues or patronage by tying in the word of the week with another promotional scheme. For example, a bookstore may have sales on all books relating to the particular culture, or a newspaper may solicit coupons from advertisers having “ethnic” products or services of relevance to the word of the week.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

I claim:

1. A method of attracting and retaining a customer base comprising:
disseminating, at regular intervals, one of a series of motivational slogans in an audio or audio/visual format;
preceding and following dissemination of said motivational slogan with an advertisement or notice of a promotional plan.

2. The method of claim 1 wherein dissemination of said motivational slogans is accomplished by RF broadcast of a radio or television signal.

3. The method of claim 1 wherein dissemination of said motivational slogans is accomplished by audio announcement at a sporting event.

4. In an arrangement comprising plural computers connected to a digital computer network, said network carrying and routing digital information between said plural computers, said plural computers including at least one personal computer associated with at least one user, at least one motivational slogan generating computer associated with at least one provider of motivational slogans, said network being decentralized in that any pair of said personal and motivational slogan computers may communicate without said communication passing through any other pair of said personal and motivational slogan computers, said personal computer having a display device and at least one user input device, the display device being capable of providing a visual display based at least in part on the digital information delivered to the personal computer via said network, said displayed information including at least one visual link associated with one of said motivational slogan computers, said user being able to operate said user input device to select and activate said link in order to effect a network connection to said motivational slogan computer, a method of directing human attention to a specific message stored on said motivational slogan computer, said message capable of being transmitted over said network to said personal computer for display in audio or visual form, the method comprising:
generating a list of motivational slogans and preparing individual entries from said list for electronic storage on said motivational slogan computer;
storing said individual entries on said motivational slogan computer;
transmitting (highlighting) said visual link to (on) said personal computer at predetermined intervals;
transmitting one of said individual entries to said personal computer for display thereon in response to selection of said visual link by said user; and,
transmitting said specific message to said personal computer following display of said individual entry.

5. A method of attracting and retaining a customer base for a retail or service oriented commercial entity comprising:
storing, in digital form, a series of motivational slogans on a wristwatch, said wristwatch having means for reproducing said slogans in audible form;
distributing said wristwatch to potential customers;
programming said wristwatch for announcements of one of said slogans at predetermined intervals;
discounting items or services for a specified time period, the period during which said items or services is discounted coinciding with the announcements of said slogans;
whereby the announcement of said slogan serves as a reminder to said potential customers of the time period during which said items or service are discounted.
